(19) United States
(12) Patent Application Publication
(10) Pub. No.: US 2018/0174281 A1
(43) Pub. Date: Jun. 21, 2018

(54) VISUAL ENHANCEMENT AND COGNITIVE ASSISTANCE SYSTEM

(71) Applicant: Microsoft Technology Licensing, LLC, Redmond, WA (US)

(72) Inventor: Brian Matthew Smith, Redmond, WA (US)

(73) Assignee: Microsoft Technology Licensing, LLC, Redmond, WA (US)

(21) Appl. No.: 15/381,050

(22) Filed: Dec. 15, 2016

(51) Int. Cl. G06T 5/00; G06T 11/00; G06K 9/18; G06T 19/20; G09B 21/00

(52) U.S. Cl. CPC G06T 5/008; G06T 5/009; G06T 11/001; G06K 9/18; G06T 2207/20208; G09B 21/008; G09B 21/006; G06T 2207/10024; G06T 19/20

(57) ABSTRACT

Systems, methods and computer-readable media for providing a visual enhancement system are disclosed. According to aspects, when a user is displaying media on a computing system, the user may enable visual enhancements to the media. The visual enhancement system includes various options for improving the accessibility and visibility of the displayed media. According to one aspect, the visual enhancement system includes functionality to provide real-time image enhancement of the displayed media. According to another aspect, the visual enhancement system includes functionality to provide on-demand cognitive assistance for the displayed media. The visual enhancement system provides numerous advantages in the presentation of media, including the implementation of image enhancements for universal media formats/types, real-time visual enhancements to the media, and improvements to the efficiency and performance in providing cognitive assistance.

BACKGROUND

Millions of people suffer from low and limited vision. Unfortunately, there are limited techniques that computers can implement in order to improve visibility of items on the display. Further, there is not an established standard to enhance media to make it visible. While typical productivity applications implement high-contrast accessibility modes or magnification options, other visual media such as video games, videos, photos, etc. are unable to implement these high-contrast accessibility modes and magnification options. Specifically, use of the high-contrast accessibility modes or magnification options with these types of media are unavailable because the functionality is not provided in real time. As a result, the high-contrast accessibility modes stop working when a user starts a video or starts playing a game. Regardless, even with visual enhancement, it may not be possible for someone to read on screen text or to recognize a face or object in an image.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

Systems, methods and computer-readable media for providing a visual enhancement system are disclosed. According to aspects, when a user is displaying media on a computing system, the user may enable visual enhancements to the media. The visual enhancement system includes various options for improving the accessibility and visibility of the displayed media. According to one aspect, the visual enhancement system includes functionality to provide real-time image enhancement of the displayed media. According to another aspect, the visual enhancement system includes functionality to provide on-demand cognitive assistance for the displayed media.

The visual enhancement system provides numerous advantages in the presentation of media, including the implementation of image enhancements for universal media formats/types, real-time visual enhancements to the media, and improvements to the efficiency and performance in providing cognitive assistance. Therefore, a computer using the visual enhancement system improves the functioning of the computer itself and effects an improvement in a network or another computer.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram of a representation of an example operating environment including the visual enhancement system;

FIG. 2 is a block diagram of a representation of an example visual enhancement system;

FIG. 3 is a representation of an example operating environment including an example image enhancement engine of the visual enhancement system;

FIGS. 4A-C are representations of examples of media utilized by the image enhancement engine of the visual enhancement system;

FIGS. 5A-B are representations of examples of media utilized by the image enhancement engine of the visual enhancement system;

FIG. 6 is a representation of an example frame of media utilized by the image enhancement engine of the visual enhancement system;

FIGS. 7A-B are representations of examples of media utilized by the image enhancement engine of the visual enhancement system;

FIG. 8 is a representation of an example operating environment including an example cognitive assistance engine of the visual enhancement system;

FIG. 9 is a representation of an example frame of media utilized by the cognitive assistance engine of the visual enhancement system;

FIG. 10 is a flow chart showing general stages involved in an example method for providing the visual enhancement system;

FIG. 11 is a flow chart showing general stages involved in an example method for providing the visual enhancement system;

FIG. 12 is a block diagram illustrating example physical components of a computing device;

FIGS. 13A and 13B are block diagrams of a mobile computing device;

and

FIG. 14 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Systems, methods and computer-readable media for providing a visual enhancement system are disclosed. According to aspects, when a user is displaying media on a computing system, the user may enable visual enhancements to the media. The visual enhancement system includes various options for improving the accessibility and visibility of the displayed media. According to one aspect, the visual enhancement system includes functionality to provide real-time image enhancement of the displayed media. According to another aspect, the visual enhancement system includes functionality to provide on-demand cognitive assistance for the displayed media. The visual enhancement system provides numerous advantages in the presentation of media, including the implementation of image enhancements for universal media formats/types, real-time visual enhancements to the media, and improvements to the efficiency and performance in providing cognitive assistance. Therefore, a computer using the visual enhancement system improves the functioning of the computer itself and effects an improvement in a network or another computer.

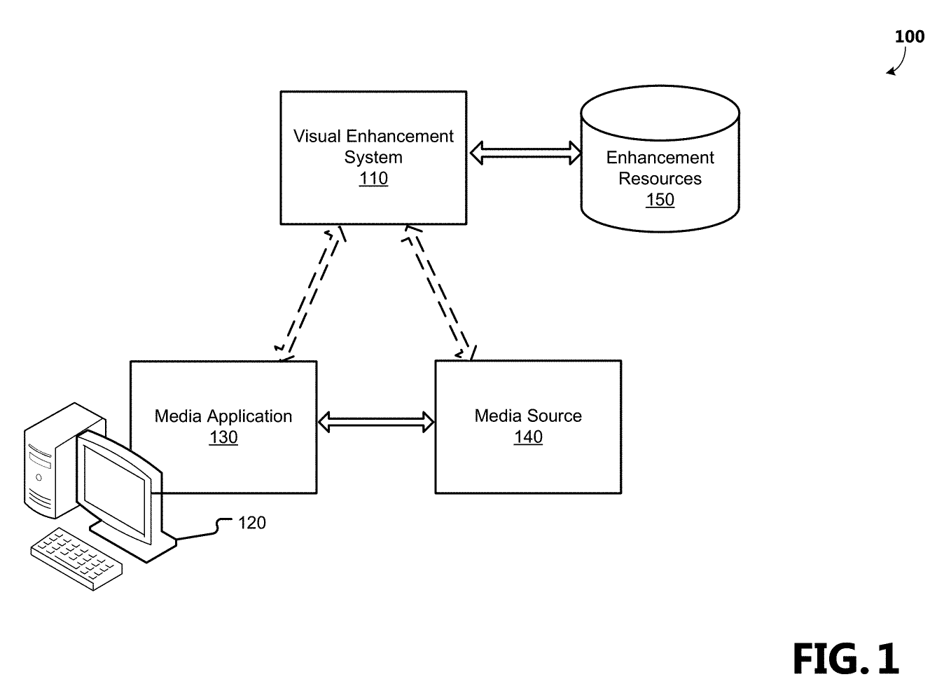

FIG. 1 is a block diagram of a representation of an example operating environment 100 including the visual enhancement system 110. As illustrated, the example environment includes a computing device 120, on which is running a media application 130. The media application 130 communicates with a media source 140 to send and/or receive media.

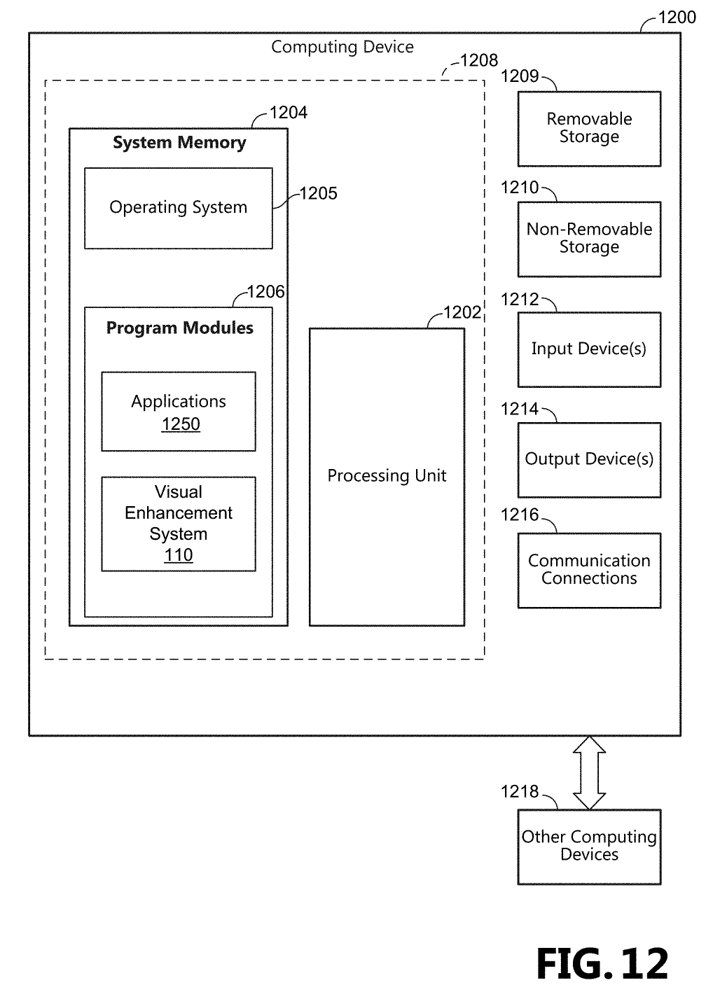

The computing device 120 is illustrative of a variety of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers. The hardware of these computing systems is discussed in greater detail in regard to FIGS. 12, 13A, 13B, and 14. In various aspects, the computing device 120 is accessible locally and/or by a network, which may include the Internet, a Local Area Network (LAN), a private distributed network for an entity (e.g., a company, a university, a government agency), a wireless ad hoc network, a Virtual Private Network (VPN) or other direct data link (e.g., Bluetooth connection, a direct wired link).

Further, the computing device 120 utilizes a media application 130 executing on the computing device 120. The media application 130 includes applications used for displaying media locally on a user machine, collaboratively across multiple user machines, or online via a server as a remote application. Examples of media application 130 that may be used locally or collaboratively include applications that provide images, pictures, videos, movies, and video games. The applications including, but are not limited to, QUICKTIME® media player (available from Apple, Inc. of Cupertino, Calif.), YOUTUBE® (offered by Alphabet, Inc. of Mountain View, Calif.), VIMEO® (offered by InterActiveCorp of New York, N.Y.), INTERNET EXPLORER® (offered by Microsoft, Corp. of Redmond, Wash.), CHROME™ (offered by Alphabet, Inc. of Mountain View, Calif.), SAFARI® (available from Apple, Inc. of Cupertino, Calif.), and the OFFICE™ suite of productivity tools (offered by Microsoft, Corp. of Redmond, Wash.).

The media application 130 communicates with a media source 140 to receive media. The media source 140 is representative of a resource that provides media to the media application 130. In one example, the media source 140 includes a remote resource such as a server that hosts media, which are streamed to the media application 130 on the computing device 120. In another example, the media source 140 includes a local resource on the computing device, including an application, video, video game, etc. Examples of media used locally or collaboratively include, but are not limited to, images, pictures, videos, movies, and video games. Such media applications 130 may store content items locally or in the cloud via cloud storage solutions, such as, for example, GOOGLE DRIVE™ or ONEDRIVE® (available from Alphabet, Inc. and Microsoft, Corp., respectively).

Further, the example operating environment 100 provides options for interacting with the visual enhancement system 110. According to one aspect, the media source 140 is in communication with a visual enhancement system 110. In one example, when the media application 130 enables visual enhancement of media being displayed, the media source 140 is a server that communicates with the visual enhancement system 110 to enhance the media displayed on the media application 130 such that the media is modified before transmission from the media source 140. More specifically, in such an example, the media source 140 performs remote server rendering of the media by communicating with the visual enhancement system 110 to perform the visual enhancements of the media, which the media source 140 streams to the media application 130 on the computing device 120. Further, it should be noted that the visual enhancement system 110 may be a separate system accessed by the media source 140 or integrated into the functionality of the media source 140. According to one aspect, the media application 130 on the computing device 120 is in communication with a visual enhancement system 110. For example, when the media application 130 is providing media, the media application 130 decodes the media and utilizes the visual enhancement system 110 to enhance the media for display. Further, it should be noted that the visual enhancement system 110 may be a separate system accessed by the media application 130, a plug-in installed into the media application 130, or otherwise integrated into the functionality of the computing device 120.

The visual enhancement system 110 is configured to improve the accessibility and visibility of the displayed media. The visual enhancement system 110 is configured to provide visual enhancement of the displayed media. The visual enhancement system 110 is in communication with enhancement resources 150, e.g., models, functionalities, resolution modifications, contrast modifications, and emphasis modifications to elements in the media to increase the visibility of the displayed media for the user. Further, the visual enhancement system 110 is configured to switch between regularly displaying the media to displaying the media in an accessibility mode based on user selection.

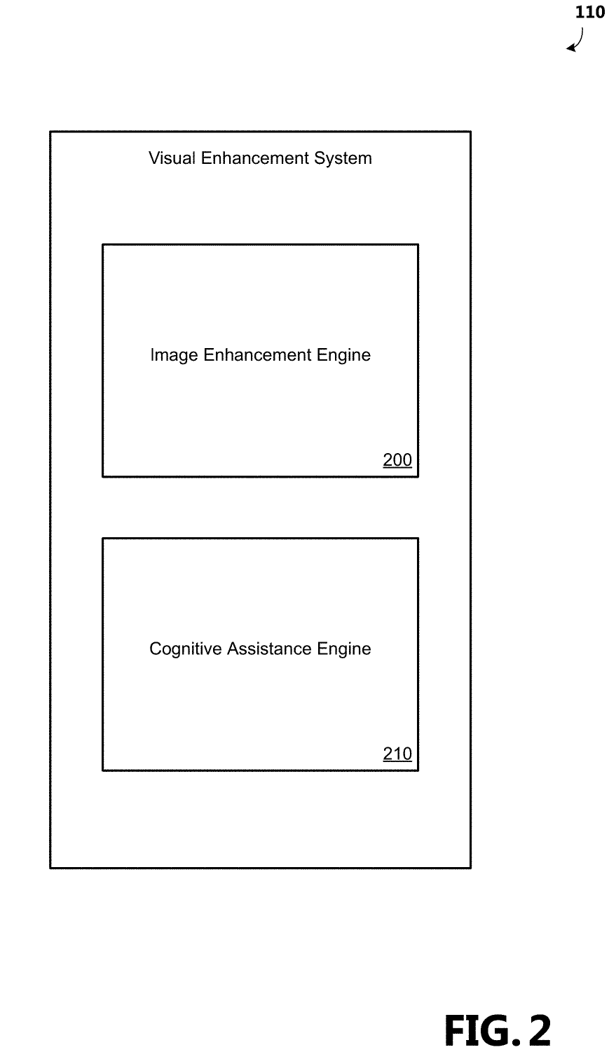

FIG. 2 is a block diagram of a representation of an example visual enhancement system 110. The visual enhancement system 110 is configured to improve the accessibility and visibility of the displayed media. The visual enhancement system 110 includes various functionalities, modules, and engines to improve the accessibility and visibility of the displayed media. As illustrated in FIG. 2, the visual enhancement system 110 includes an image enhancement engine 200 and a cognitive assistance engine 210.

The image enhancement engine 200 is configured to provide image enhancement of the displayed media. The image enhancement engine 200 may utilize functionalities, machine learning, predictive models or other artificial intelligence to improve the visibility of the displayed media. Further, the image enhancement engine 200 may provide the enhancements in real time.

The cognitive assistance engine 210 is configured to provide cognitive assistance for the displayed media. More specifically, the cognitive assistance engine 210 provides additional information to the user that identifies information about the displayed media. Further, the cognitive assistance engine 210 may provide on-demand cognitive assistance based on a user requesting cognitive assistance.

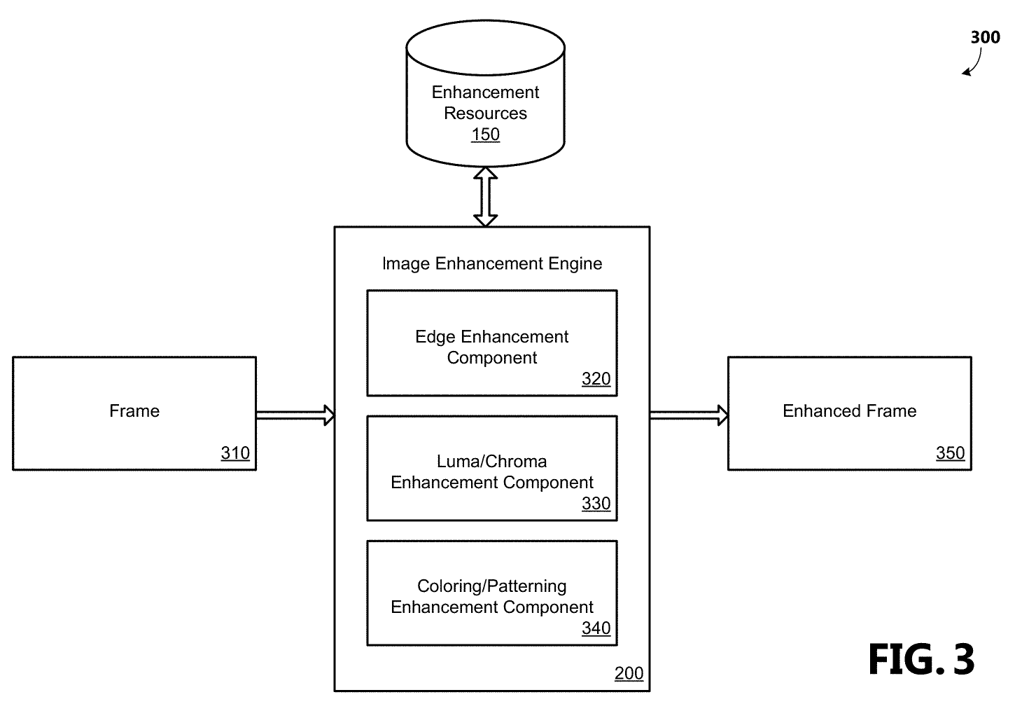

FIG. 3 is a representation of an example operating environment 300 including an image enhancement engine 200 of the visual enhancement system 110. According to one aspect, the image enhancement engine 200 is configured to capture frames 310 associated with media displayed on the display. In one example, the image enhancement engine 200 is in communication with the graphical processing unit of the computing device 120. Accordingly, the image enhancement engine 200 is able to capture each of the frames 310 from the displayed media. Further, because the image enhancement engine 200 captures frames 310 from the graphical processing unit, the image enhancement engine 200 is operable to obtain the frames 310 in real time. According to one aspect, the image enhancement engine 200 captures the frames 310 in fewer than 10 milliseconds at 60 frames per second. Accordingly, any enhancements to the image implemented by the image enhancement engine 200 remains in sync with any audio associated with the media. While the image enhancement engine 200 may capture the frames 310 at other rates, the capture rate should not result in delay that is detectable via display of the enhanced media.

Once the image enhancement engine 200 captures the frame 310, the image enhancement engine 200 is configured to provide image enhancement of the frame 310. The image enhancement engine 200 may utilize functionalities, machine learning, predictive models or other artificial intelligence to improve the visibility of the frame 310. According to various aspects, the image enhancement engine 200 may include an edge enhancement component 320, a luma/chroma enhancement component 330, and a coloring/patterning enhancement component 340. According to other examples, the image enhancement engine 200 includes functionality to provide improved visibility of motion within the frame 310.

In the illustrated example, the image enhancement engine 200 includes an edge enhancement component 320. The edge enhancement component 320 is particularly helpful to improve visibility for a frame 310 with limited contrast, which may occur based on the contrast in the frame 310, the colors used in the frame 310, or based on a user's vision impairment. The edge enhancement component 320 is operable to analyze the frame 310 and to identify edges between items in the frame 310. Once the edges between items in the frame 310 have been identified, the edge enhancement component 320 modifies the frame 310 to emphasize the edges. The type and degree of emphasis is based on the user's vision impairment or based on the preferences of the user. In one example, the edges are emphasized by highlighting or outlining the edges. In another example, the edge enhancement component 320 highlights the edges by providing a contrasting line at the edge such as a monochromatic or color line that emphasizes the edges.

In the illustrated example, the image enhancement engine 200 further includes a luma/chroma enhancement component 330. The luma/chroma enhancement component 330 improves visibility for a frame 310 with limited color or color intensities, which may occur based on the colors in the frame 310, the intensities of the colors used in the frame 310, or a user's limited visibility. The luma/chroma enhancement component 330 is operable to analyze the frame 310 and to identify colors or color intensities in the frame 310. In response to identifying the colors or color intensities in the frame 310, the luma/chroma enhancement component 330 modifies the frame 310 to improve the visibility of the colors or color intensities. The modifications to the colors or color intensities is based on the user's vision impairment or based on the preferences of the user. In one example, the chroma attributes of a frame 310 are modified to remove specific colors or gradients based on the user's vision impairment to provide solid colors that are visually distinguishable to the user. In another example, the luma attributes of a frame 310 are modified to increase or decrease the intensity of the colors or gradients based on the user's vision impairment to provide varying intensities that are visually distinguishable to the user.

In the illustrated example, the image enhancement engine 200 further includes a coloring/patterning enhancement component 340. The coloring/patterning enhancement component 340 improves visibility for a frame 310 with problematic colors, which may occur based on a user's limited visibility such as color blindness. The coloring/patterning enhancement component 340 is operable to analyze the frame 310, identify problematic colors in the frame 310 and to map the locations of the problematic colors in the frame 310. In response to identifying the problematic colors in the frame 310, the coloring/patterning enhancement component 340 modifies the frame 310 to improve the visibility of the problematic colors. According to one aspect, the colors of a frame 310 are modified to modify specific colors that are problematic to the user's visibility. For example, the frame 310 may be modified to distinguish between reds or greens that are adjacent, including substituting distinguishable colors for one of the problematic colors, modifying the colors to include hatching or gradients, addition of stippling having a distinguishable color, applying a pattern to the problematic colors, and the like. Further, the coloring/patterning enhancement component 340 may include profiles associated with the coloring and patterning options. The profiles may include options for the most common types of visibility issues. In one example, the coloring/patterning profiles may account for the various types of color blindness. In another example, the coloring/patterning profile is merely based on the user preferences for viewing the media.

According to another aspect, the image enhancement engine 200 further includes a macroblock/motion enhancement component. The image enhancement engine 200 is also operable to utilize the rich data stream of frames 310 captured from the graphical processing unit of the computing device 120. For example, the decoding engines may be augmented to expose or apply accessibility transforms as part of rendering process. Accordingly, the image enhancement engine 200 is operable to identify object boundaries and motion vectors that indicate frame deltas, which are utilized to isolate moving objects. Thus, the image enhancement engine 200 is operable to detect motion vectors based on different positions and different orientations. As a result, each frame 310 is modifiable to include motion vectors on the media.

According to another aspect, the image enhancement engine 200 further includes 3D graphic enhancement component. While 3D graphics utilize a plurality of different engines, the image enhancement engine 200 is able to utilize one or more drivers to natively understand the unique 3D graphic engines. The image enhancement engine 200 leverages the powerful enhancements for any 3D graphic engines in order to identify attributes in the 3D graphics to identify where objects exist in space. Accordingly, the 3D graphic enhancement component is operable to isolate and provide contrast between each of the objects. For example, the 3D graphic enhancement component is operable to focus on foreground objects, background objects, and moving objects. Further, 3D graphic enhancement component is configured to identify vertex data that allows the image enhancement engine 200 to observe how fast that vertex moved from frame-to-frame.

Further, it should be noted, that the image enhancement engine 200 may implement one or more of the functionalities based on aspects of the media or preferences of the user. More specifically, the image enhancement engine 200 utilizes one or more of the edge enhancement component 320, the luma/chroma enhancement component 330, the coloring/patterning enhancement component 340, the macroblock/motion enhancement component, and the 3D graphic enhancement component. It should be recognized that based on the selected components, the image enhancement engine 200 provides various advantages, including improved visibility of edges, colors, and motion.

According to one aspect, the image enhancement engine 200 is in communication with enhancement resources 150 comprising predictive models, machine learning systems, or other artificial intelligence to improve the visibility of the displayed media, which may include resolution modifications, contrast modifications, re-coloring/patterning modifications, isolation modifications and emphasis modifications to elements in the media.

In one example, the predictive model may be configured to provide information relating to the user's preferences for image enhancement. Further, it should be recognized that the predictive model is built and trained based on a training model that defines the image enhancement preference models based on observed patterns, including information relating to the user's profile data, edge modifications, luma/chroma modifications, color/patterning modifications, and motion modifications. The training model refines the image enhancement preferences model using a machine learning approach that verifies its accuracy using the image enhancements and modifications as a training set to verify the accuracy of the image enhancement preference models.

In another example, the predictive model may be configured to provide the image enhancement. More specifically, the predictive model is configured to utilize the observed patterns to generate image enhancements. The predictive model is built and trained based on a training model that defines the image enhancement models and refines the image enhancement to verify accuracy.

Thus, the predictive model provides one or more predictive results, such as image enhancement preferences and/or image enhancements, in response to receiving a respective request. Further, the predictive model may provide results based on a weighted average. For example, the predictive model may generate multiple predictions associated with the user's image enhancement preferences and/or image enhancements. In response to generating multiple predictions, the predictive model may present the result as a weighted average. In another example, the predictive model provides a confidence score associated with the prediction based on the differences with the multiple predictions.

In response to the image enhancements to improve the visibility of the frames 310, the image enhancement engine 200 produces an enhanced frame 350 with improved visibility.

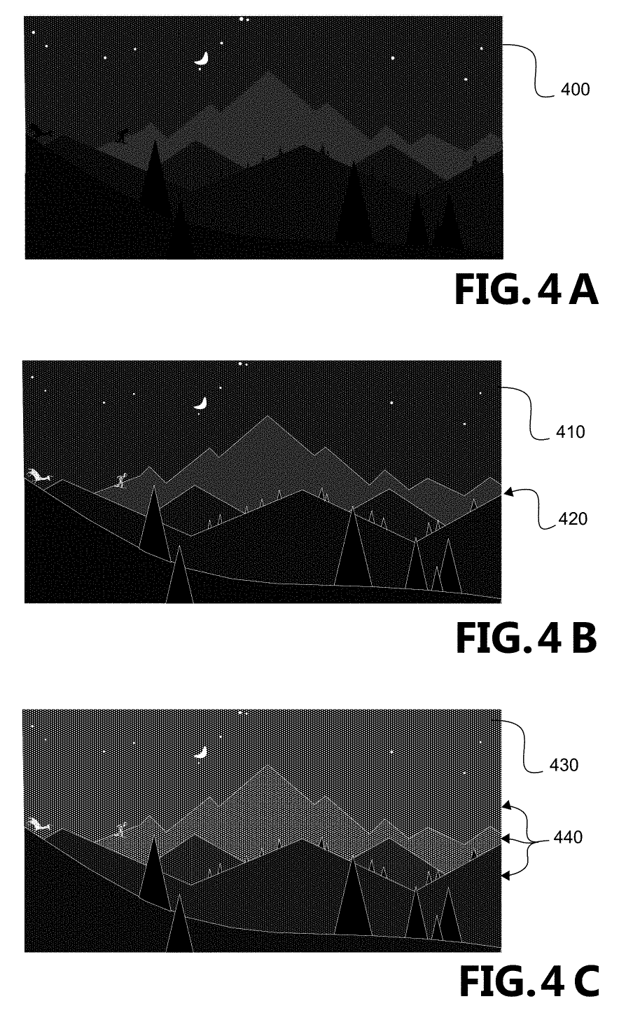

FIGS. 4A-C are representations of example media utilized by the image enhancement engine 200 of the visual enhancement system 110. More specifically, the image enhancement engine 200 uses an edge enhancement component 320 and a luma/chroma enhancement component 330 to improve visibility for a frame.

FIG. 4A illustrates an example frame 400 that depicts a scene having limited visibility. The limited visibility in the frame 400 may be a result of contrast limitations in the frame 400, the selection of colors used in the frame 400, or a user's vision impairment.

Further, FIG. 4B illustrates an edge-enhanced frame 410 that depicts the scene having edge enhancements. More specifically, the example frame 400 illustrated in FIG. 4A has been enhanced by the edge enhancement component 320 to emphasize the edges 420. The edge enhancements are generally configured to emphasize the edges 420 between the objects. According to certain aspects, the color of the edge enhancements is selected from one or more colors that contrast with the colors adjacent to the edge. For example, in the illustrated scene, the edges 420 are enhanced by white to maximize the contrast. The color of the edge enhancements may be selected based on other user preferences.

Further, FIG. 4C illustrates an edge-enhanced and luma/chroma-enhanced frame 430 that depicts the scene having edge and luma/chroma enhancements. More specifically, the edge-enhanced frame 410 illustrated in FIG. 4B has been enhanced by the luma/chroma enhancement component 330 to improve color or color intensities within the edge-enhanced frame 410. According to certain aspects, the modifications to the colors or color intensities are based on user preferences or a setting associated with the user's vision impairment. In one example, the chroma attributes of a non-edge-enhanced frame are modified to remove specific colors or gradients based on the user's vision impairment to provide colors or gradients (e.g., particular hatching, solid colors) 440 that are visually distinguishable to the user. In another example, the luma attributes of a frame are modified to increase or decrease the intensity of the colors or gradients to provide intensities that are visually distinguishable to the user.

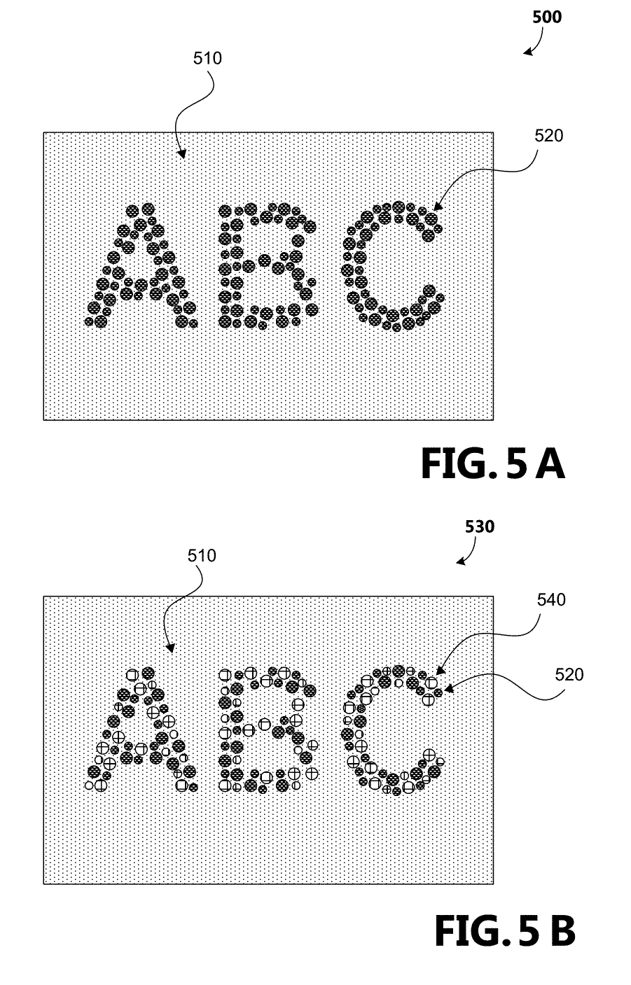

FIGS. 5A-B are representations of examples of media utilized by the image enhancement engine 200 of the visual enhancement system 110. More specifically, the image enhancement engine 200 includes a coloring/patterning enhancement component 340 to improve visibility for a frame with problematic colors.

FIG. 5A illustrates an example frame 500 that depicts a scene having limited visibility. The limited visibility in the frame 500 may be a result of contrast limitations in the frame 500, the selection of colors used in the frame 500, or a user's vision impairment such as color blindness. In the illustrated frame 500, a user may experience limited visibility when attempting to discern the letters from the background. For example, the background 510 may include green coloring and the letters 520 include red coloring. While some users may not have visibility issues, red/green colorblindness is a fairly common visibility issue, which will cause visibility issues for some users.

Further, FIG. 5B illustrates a coloring/patterning-enhanced frame 530 that depicts the scene having coloring/patterning enhancements. More specifically, the example frame 500 illustrated in FIG. 5A has been enhanced by the coloring/patterning enhancement component 340 to improve visibility and emphasize the items displayed in the frame. According to aspects the problematic colors in the frame 500 are recolored or patterned in order to provide a clear differentiation of colors. In the illustrated coloring/patterning-enhanced frame 530, the colors/patterns of the text are modified to more than a single color/pattern. With reference to the example above, at least a portion of the letters 520 are recolored to include letters 540 having another color, such as blue letters, to be displayed on the green background 510, thus making the letters 520 more discernable to a user with red/green colorblindness and other users without vision impairments.

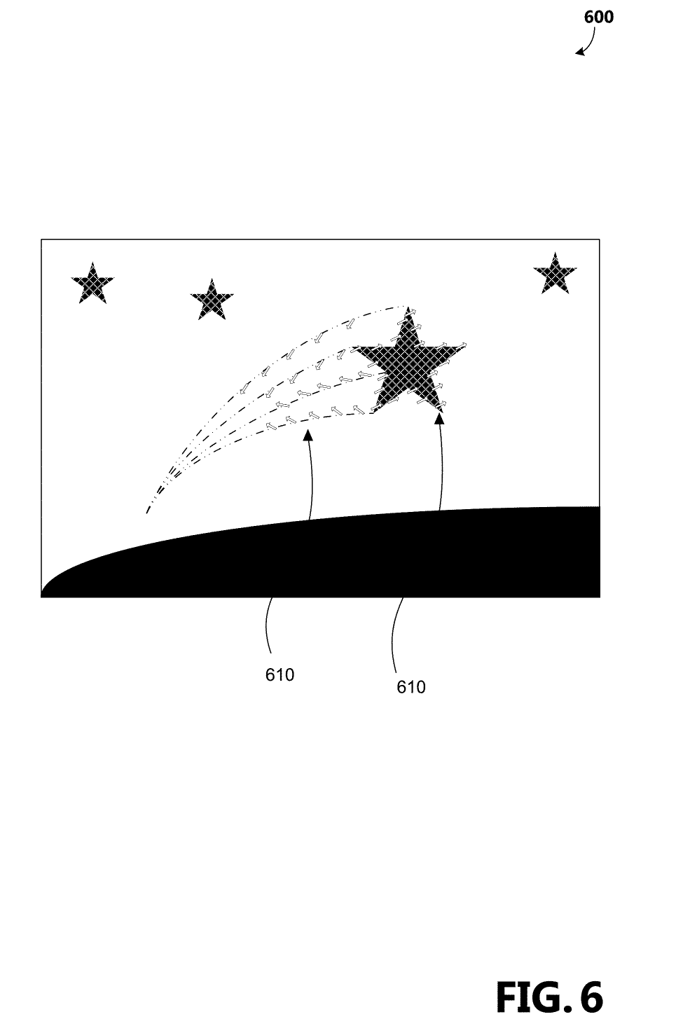

FIG. 6 is a representation of an example enhanced frame 600 of media utilized by the image enhancement engine 200 of the visual enhancement system 110. More specifically, the image enhancement engine 200 includes a macroblock/motion enhancement component to improve visibility of moving objects within a frame. Based on the attributes in the rendering process, the frame is enhanced to include information regarding motion within the frame. For example, in the illustrated enhanced frame 600, the star and its tailing are moving through the sky. Accordingly, the macroblock/motion enhancement component is able to identify object boundaries and motion vectors that indicate frame deltas based on the rendering process. As such, the macroblock/motion enhancement component is operable to display the motion attributes in the frame. For example, the star and its tailing are illustrated with motion vectors 610 that identify the magnitude and orientation of how the object is moving to the user. Further, if desired, the moving object may be isolated from non-moving objects.

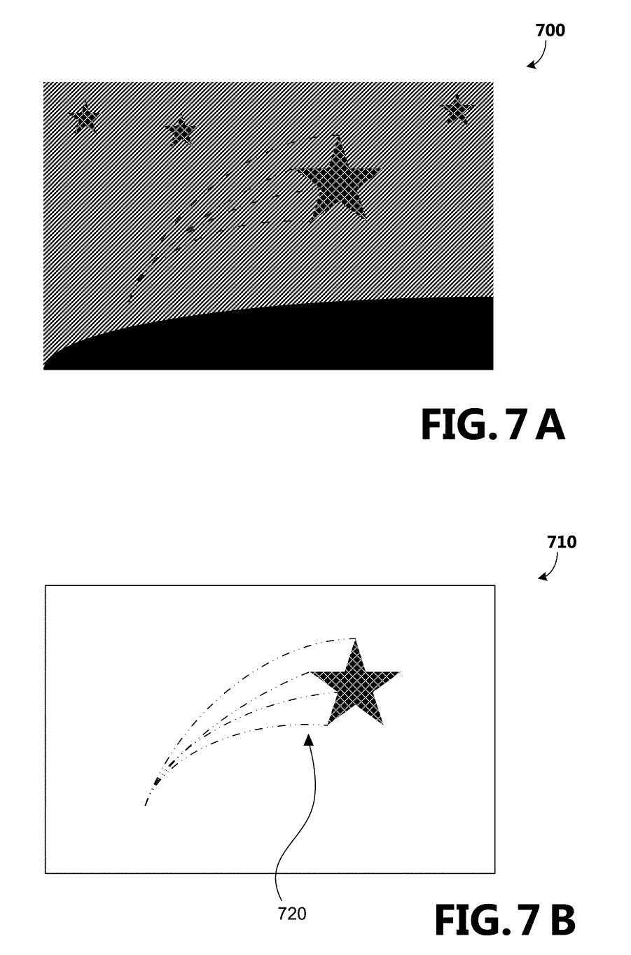

FIGS. 7A-B are representations of examples of media utilized by the image enhancement engine 200 of the visual enhancement system 110. More specifically, the image enhancement engine 200 includes a 3D graphic enhancement component to identify and improve visibility of objects displayed in space.

FIG. 7A illustrates an example frame 700 that depicts a scene having limited visibility. However, the 3D graphic enhancement component is operable to universally receive and process graphical information provided by various 3D graphic engines. As illustrated in the enhanced frame 710 depicted in FIG. 7B, the 3D graphic enhancement component is operable to isolate and provide contrast between each of the objects. In the illustrated frame, the moving objects 720 have been isolated from the remainder of the screen. However, the 3D graphic enhancement component is also operable to focus on foreground objects, background objects, or other objects of interest.

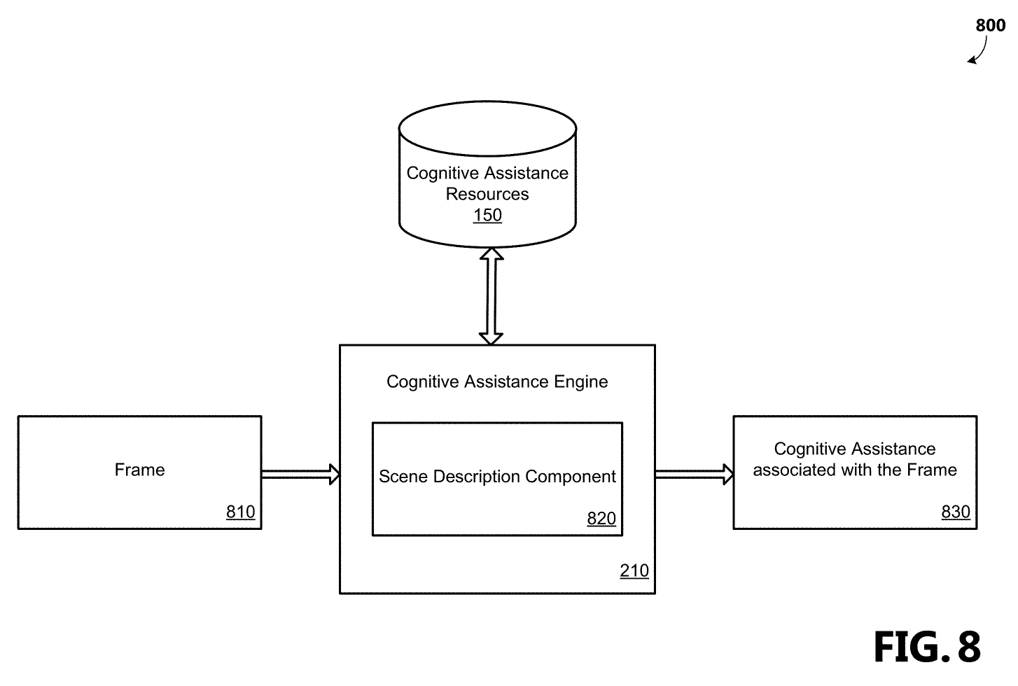

FIG. 8 is a representation of an example operating environment 800 including an example cognitive assistance engine 210 of the visual enhancement system 110. Many users have difficultly identifying what is being displayed in a scene. Further, other users may have difficultly reading the text that is displayed in a scene. Accordingly, the cognitive assistance engine 210 is able to provide a scene description that provides the user with a description of the scene or text displayed.

The cognitive assistance engine 210 is provided on-demand. According to aspects, the user requests cognitive assistance for the displayed scene. In one example, the user hits the space button to enable functionality providing cognitive assistance. The cognitive assistance engine 210 may otherwise provide controls for enabling cognitive assistance.

According to one aspect, the cognitive assistance engine 210 is configured to capture frames 810 associated with media displayed on the display. In one example, the cognitive assistance engine 210 is in communication with the graphical processing unit of the computing device 120. Accordingly, the cognitive assistance engine 210 is able to capture each of the frames 810 from the displayed media. Further, because the cognitive assistance engine 210 captures frames 810 from the graphical processing unit, the cognitive assistance engine 210 is operable to obtain the frames 810 in real time. According to one aspect, the cognitive assistance engine 210 captures the frames in fewer than 10 milliseconds at 60 frames per second. Accordingly, any cognitive assistance implemented by the cognitive assistance engine 210 remains in sync with any video and audio associated with the media. While the cognitive assistance engine 210 may capture the frames 810 at other rates, the capture rate should not result in delay that is detectable via display of the enhanced media.

Once the cognitive assistance engine 210 captures the frame 810, the cognitive assistance engine 210 is configured to provide cognitive assistance for the frame 810. In the illustrated example, the cognitive assistance engine 210 includes a scene description component 820. The scene description component 820 is particularly helpful to provide the user with a description of the scene or description of the text that is displayed. In one example, if text is being displayed, the cognitive assistance engine 210 captures the text being displayed, performs optical character recognition of the text, and provides the user with additional information about the text being displayed. In another example, if an image is being displayed, the cognitive assistance engine 210 captures the image being displayed, determines what the image is portraying, and a scene description is provided to the user with additional information about the image being displayed.

In order to provide the scene description, the scene description component 820 may utilize various functionalities, machine learning, predictive models or other artificial intelligence to provide cognitive assistance for the frame 810. According to one aspect, the cognitive assistance engine 210 is in communication with enhancement resources 150 comprising predictive models, machine learning systems, or other artificial intelligence to provide cognitive assistance 830 for the displayed media.

In one example, the predictive model may be configured to provide information relating to the displayed media. Further, it should be recognized that the predictive model is built and trained based on a training model that defines the cognitive assistance models based on images captured from a variety of sources, including websites, social media, photographs, etc. Optimally, each image provides some contextual information about the objects in the image. In various examples, the images contextual information such as labels, hashtags, or descriptions. Further, when the images are captured from social media, the objects within the images frequently include identifying attributes about the object. The training model refines the cognitive assistance model using a machine learning approach that verifies its accuracy using the cognitive assistance and modifications as a training set to verify the accuracy of the cognitive assistance models. More specifically, the training model may receive feedback that further provides training for the models.

Additionally, the predictive model provides one or more predictive results, such as cognitive assistance, in response to receiving a respective request. Further, the predictive model may provide results based on a weighted average. For example, the predictive model may generate multiple predictions associated with cognitive assistance. In response to generating multiple predictions, the predictive model may present the result as a weighted average. In another example, the predictive model provides a confidence score associated with the prediction based on the differences with the multiple predictions.

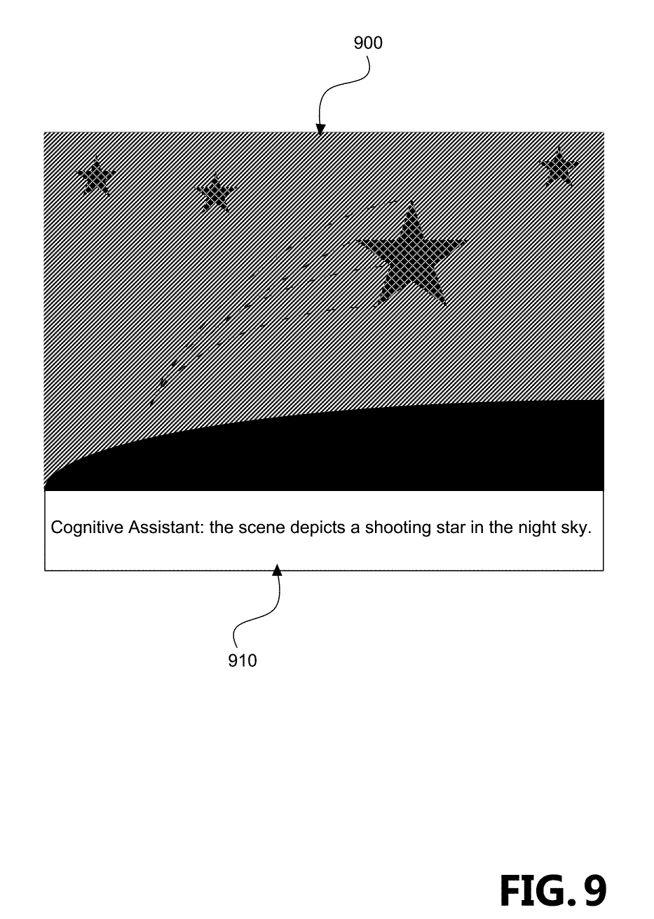

FIG. 9 is a representation of an example frame 900 of media utilized by the cognitive assistance engine 210 of the visual enhancement system 110. In the illustrated example, the cognitive assistance engine 210 includes a scene description 910 associated with the example frame 900. The scene description 910 is particularly helpful to provide the user with a description of the scene or description of the text that is displayed. For example, if text is being displayed, the cognitive assistance engine 210 captures the text being displayed, performs optical character recognition of the text, and provides the user with the scene description (e.g., text) 910, which is presented via text or audio. In the illustrated example frame 900, when an image is being displayed, the cognitive assistance engine 210 captures the image being displayed, determines what the image is portraying, and provides a scene description 910, which conveys information about the image being displayed. As illustrated in FIG. 9, a scene description 910 is visually displayed below the displayed media identifying that “the scene depicts a shooting star in the night sky,” which may also be provided audibly.

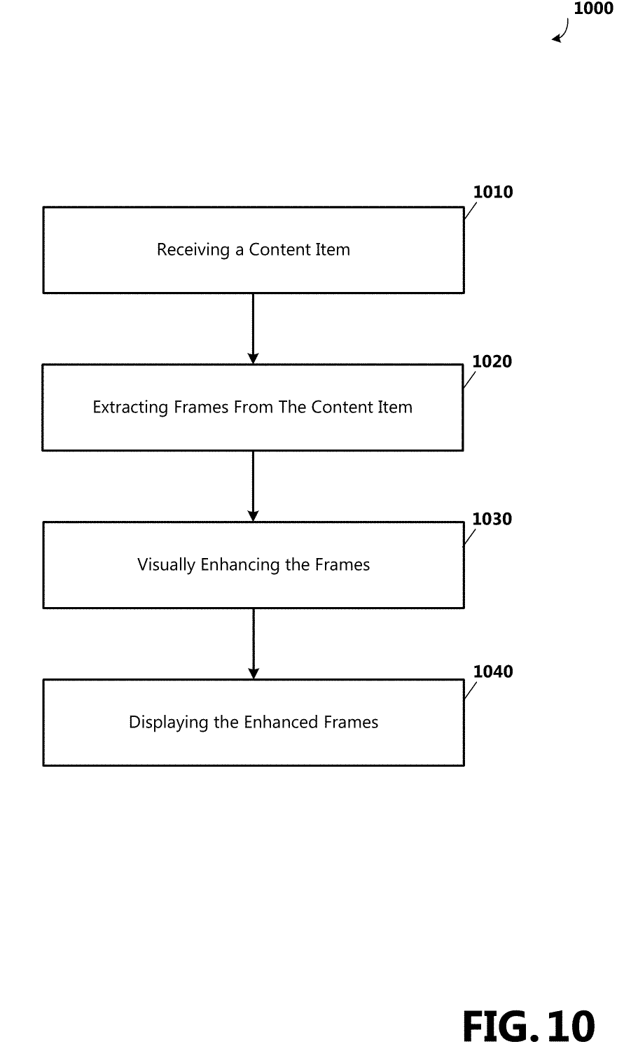

FIG. 10 is a flow chart showing general stages involved in an example method 1000 for providing the visual enhancement system 110.

Method 1000 begins at OPERATION 1010 where the visual enhancement system 110 receives a content item. The content item may include, but is not limited to, an image, a picture, a video, a movie, and a video game. Moreover, the content item may be provided by a remote resource, such as a server that hosts media, or a local resource on the computing device, including an application, video, video game, etc.

Method 1000 then proceeds to OPERATION 1020, where the visual enhancement system 110 extracts frames from the content item. In one example, the visual enhancement system 110 captures frames 310 from the graphical processing unit, such that the frames are captured in real time.

Method 1000 then proceeds to OPERATION 1030, where the visual enhancement system 110 visually enhances the frames. According to one aspect, the method may include performing edge enhancements to emphasize the edges in the frames. More particularly, the edge enhancements may be configured to emphasize the edges by modifying each edge to contrast with the adjacent areas.

According to another aspect, the method may include performing luma/chroma enhancements to distinguish items displayed in the frames. In one example, the luma/chroma enhancements may modify the colors to distinguish the items displayed in the frames. In another example, the luma/chroma enhancements may increase or decrease the intensity of the colors to distinguish the items displayed in the frames.

According to yet another aspect, the method may include performing coloring/patterning enhancements to distinguish items displayed in the frames. More particularly, the coloring/patterning enhancements may apply a pattern having a distinguishable color to the items displayed in the frames to differentiation the items displayed in the frame.

Method 1000 then proceeds to OPERATION 1040, where the visual enhancement system 110 displays the enhanced frames.

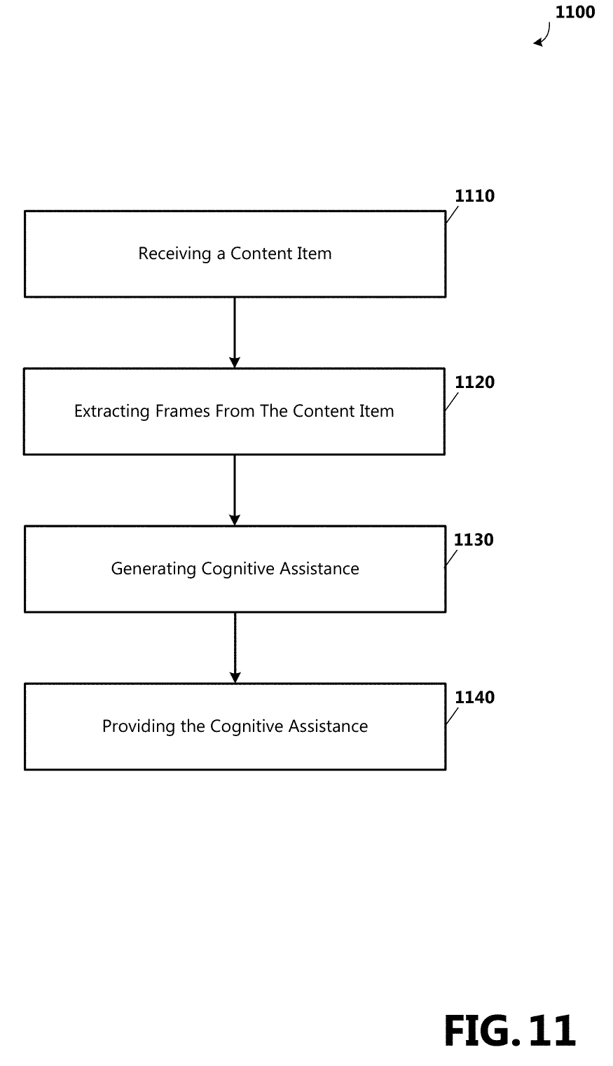

FIG. 11 is a flow chart showing general stages involved in an example method 1100 for providing the visual enhancement system 110.

Method 1100 begins at OPERATION 1110 where the visual enhancement system 110 receives a content item. The content item may include, but is not limited to, an image, a picture, a video, a movie, and a video game. Moreover, the content item may be provided by a remote resource, such as a server that hosts media, or a local resource on the computing device, including an application, video, video game, etc.

Method 1100 then proceeds to OPERATION 1120, where the visual enhancement system 110 extracts frames from the content item. In one example, the visual enhancement system 110 captures frames from the graphical processing unit, such that the frames are captured in real time.

Method 1100 then proceeds to OPERATION 1130, where the visual enhancement system 110 generates cognitive assistance.

According to one the visual enhancement system 110 generates a scene description to provide cognitive assistance. In one example, the visual enhancement system 110 generates a scene description by capturing an image displayed in a frame, identifying similar images, and generating a description of the image based on similarities with other images. In one example, the visual enhancement system 110 generates a scene description by capturing text displayed in a frame, performing optical character recognition of the text, and audibly or visually providing the text to the user.

Method 1100 then proceeds to OPERATION 1140, where the visual enhancement system 110 provides the cognitive assistance. In one example, the cognitive assistance is displayed on the text in an accessible mode. In another example, the cognitive assistance is audibly presented to the user.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 12-14 and the associated descriptions provide a discussion of a variety of operating environments in which examples are practiced. However, the devices and systems illustrated and discussed with respect to FIGS. 12-14 are for purposes of example and illustration and are not limiting of a vast number of computing device configurations that are utilized for practicing aspects, described herein.

FIG. 12 is a block diagram illustrating physical components (i.e., hardware) of a computing device 1200 with which examples of the present disclosure may be practiced. In a basic configuration, the computing device 1200 includes at least one processing unit 1202 and a system memory 1204. According to an aspect, depending on the configuration and type of computing device, the system memory 1204 comprises, but is not limited to, volatile storage (e.g., random access memory), non-volatile storage (e.g., read-only memory), flash memory, or any combination of such memories. According to an aspect, the system memory 1204 includes an operating system 1205 and one or more program modules 1206 suitable for running software applications 1250. According to an aspect, the system memory 1204 includes visual enhancement system 110. The operating system 1205, for example, is suitable for controlling the operation of the computing device 1200. Furthermore, aspects are practiced in conjunction with a graphics library, other operating systems, or any other application program, and are not limited to any particular application or system. This basic configuration is illustrated in FIG. 12 by those components within a dashed line 1208. According to an aspect, the computing device 1200 has additional features or functionality. For example, according to an aspect, the computing device 1200 includes additional data storage devices (removable and/or non-removable) such as, for example, magnetic disks, optical disks, or tape. Such additional storage is illustrated in FIG. 12 by a removable storage device 1209 and a non-removable storage device 1210.

As stated above, according to an aspect, a number of program modules and data files are stored in the system memory 1204. While executing on the processing unit 1202, the program modules 1206 (e.g., visual enhancement system 110) perform processes including, but not limited to, one or more of the stages of the methods 1000 and 1100 illustrated in FIGS. 10-11. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 12 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 1200 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 1200 has one or more input device(s) 1212 such as a keyboard, a mouse, a pen, a sound input device, a touch input device, etc. The output device(s) 1214 such as a display, speakers, a printer, etc. are also included according to an aspect. The aforementioned devices are examples and others may be used. According to an aspect, the computing device 1200 includes one or more communication connections 1216 allowing communications with other computing devices 1218. Examples of suitable communication connections 1216 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 1204, the removable storage device 1209, and the non-removable storage device 1210 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1200. According to an aspect, any such computer storage media is part of the computing device 1200. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

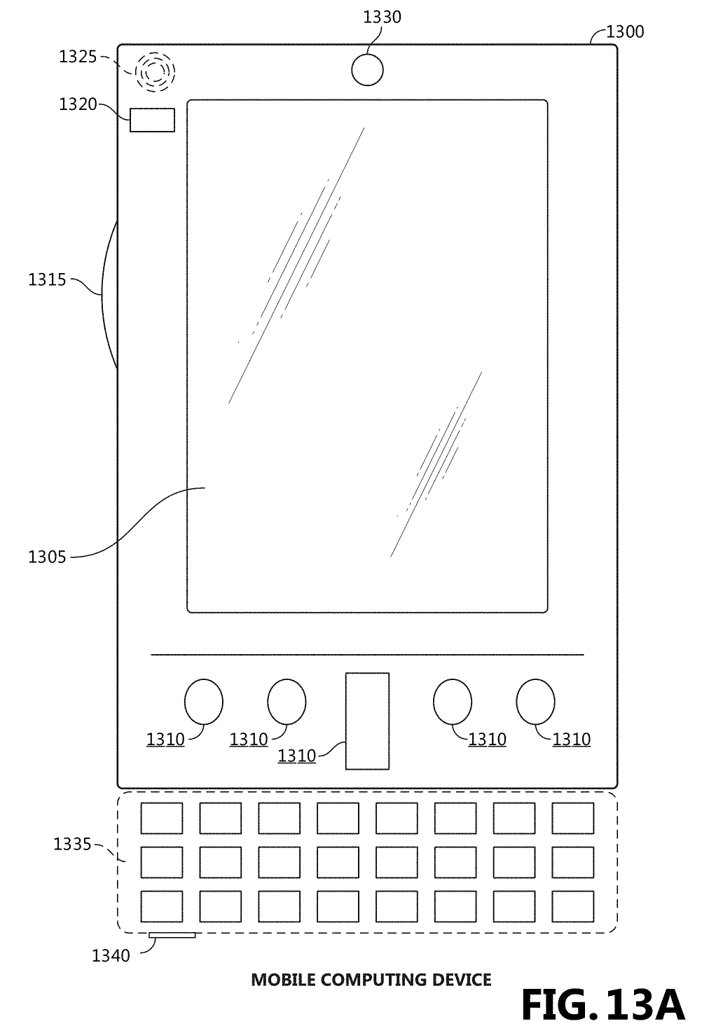

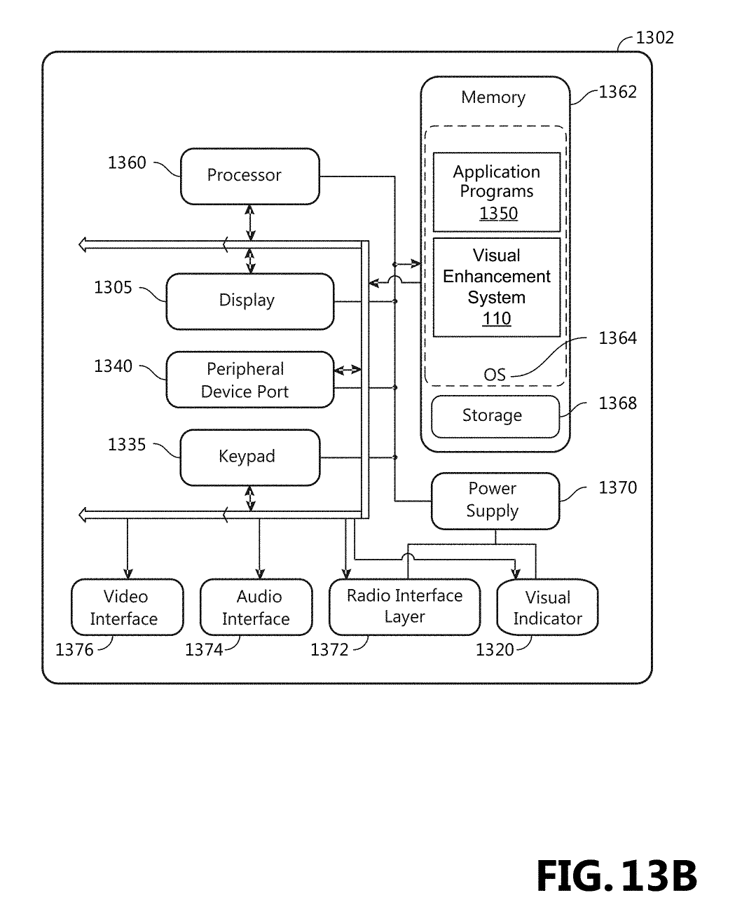

FIGS. 13A and 13B illustrate a mobile computing device 1300, for example, a mobile telephone, a smart phone, a tablet personal computer, a laptop computer, and the like, with which aspects may be practiced. With reference to FIG. 13A, an example of a mobile computing device 1300 for implementing the aspects is illustrated. In a basic configuration, the mobile computing device 1300 is a handheld computer having both input elements and output elements. The mobile computing device 1300 typically includes a display 1305 and one or more input buttons 1310 that allow the user to enter information into the mobile computing device 1300. According to an aspect, the display 1305 of the mobile computing device 1300 functions as an input device (e.g., a touch screen display). If included, an optional side input element 1315 allows further user input. According to an aspect, the side input element 1315 is a rotary switch, a button, or any other type of manual input element. In alternative examples, mobile computing device 1300 incorporates more or fewer input elements. For example, the display 1305 may not be a touch screen in some examples. In alternative examples, the mobile computing device 1300 is a portable phone system, such as a cellular phone. According to an aspect, the mobile computing device 1300 includes an optional keypad 1335. According to an aspect, the optional keypad 1335 is a physical keypad. According to another aspect, the optional keypad 1335 is a “soft” keypad generated on the touch screen display. In various aspects, the output elements include the display 1305 for showing a graphical user interface (GUI), a visual indicator 1320 (e.g., a light emitting diode), and/or an audio transducer 1325 (e.g., a speaker). In some examples, the mobile computing device 1300 incorporates a vibration transducer for providing the user with tactile feedback. In yet another example, the mobile computing device 1300 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 1300 incorporates peripheral device port 1340, such as an audio input (e.g., a microphone jack), an audio output (e.g., a headphone jack), and a video output (e.g., a HDMI port) for sending signals to or receiving signals from an external device.

FIG. 13B is a block diagram illustrating the architecture of one example of a mobile computing device. That is, the mobile computing device 1300 incorporates a system (i.e., an architecture) 1302 to implement some examples. In one example, the system 1302 is implemented as a “smart phone” capable of running one or more applications (e.g., browser, e-mail, calendaring, contact managers, messaging clients, games, and media clients/players). In some examples, the system 1302 is integrated as a computing device, such as an integrated personal digital assistant (PDA) and wireless phone.

According to an aspect, one or more application programs 1350 are loaded into the memory 1362 and run on or in association with the operating system 1364. Examples of the application programs include phone dialer programs, e-mail programs, personal information management (PIM) programs, word processing programs, spreadsheet programs, Internet browser programs, messaging programs, and so forth. According to an aspect, visual enhancement system 110 is loaded into memory 1362. The system 1302 also includes a non-volatile storage area 1368 within the memory 1362. The non-volatile storage area 1368 is used to store persistent information that should not be lost if the system 1302 is powered down. The application programs 1350 may use and store information in the non-volatile storage area 1368, such as e-mail or other messages used by an e-mail application, and the like. A synchronization application (not shown) also resides on the system 1302 and is programmed to interact with a corresponding synchronization application resident on a host computer to keep the information stored in the non-volatile storage area 1368 synchronized with corresponding information stored at the host computer. As should be appreciated, other applications may be loaded into the memory 1362 and run on the mobile computing device 1300.

According to an aspect, the system 1302 has a power supply 1370, which is implemented as one or more batteries. According to an aspect, the power supply 1370 further includes an external power source, such as an AC adapter or a powered docking cradle that supplements or recharges the batteries.

According to an aspect, the system 1302 includes a radio 1372 that performs the function of transmitting and receiving radio frequency communications. The radio 1372 facilitates wireless connectivity between the system 1302 and the “outside world,” via a communications carrier or service provider. Transmissions to and from the radio 1372 are conducted under control of the operating system 1364. In other words, communications received by the radio 1372 may be disseminated to the application programs 1350 via the operating system 1364, and vice versa.

According to an aspect, the visual indicator 1320 is used to provide visual notifications and/or an audio interface 1374 is used for producing audible notifications via the audio transducer 1325. In the illustrated example, the visual indicator 1320 is a light emitting diode (LED) and the audio transducer 1325 is a speaker. These devices may be directly coupled to the power supply 1370 so that when activated, they remain on for a duration dictated by the notification mechanism even though the processor 1360 and other components might shut down for conserving battery power. The LED may be programmed to remain on indefinitely until the user takes action to indicate the powered-on status of the device. The audio interface 1374 is used to provide audible signals to and receive audible signals from the user. For example, in addition to being coupled to the audio transducer 1325, the audio interface 1374 may also be coupled to a microphone to receive audible input, such as to facilitate a telephone conversation. According to an aspect, the system 1302 further includes a video interface 1376 that enables an operation of an on-board camera 1330 to record still images, video stream, and the like.

According to an aspect, a mobile computing device 1300 implementing the system 1302 has additional features or functionality. For example, the mobile computing device 1300 includes additional data storage devices (removable and/or non-removable) such as, magnetic disks, optical disks, or tape. Such additional storage is illustrated in FIG. 13B by the non-volatile storage area 1368.

According to an aspect, data/information generated or captured by the mobile computing device 1300 and stored via the system 1302 are stored locally on the mobile computing device 1300, as described above. According to another aspect, the data are stored on any number of storage media that are accessible by the device via the radio 1372 or via a wired connection between the mobile computing device 1300 and a separate computing device associated with the mobile computing device 1300, for example, a server computer in a distributed computing network, such as the Internet. As should be appreciated such data/information are accessible via the mobile computing device 1300 via the radio 1372 or via a distributed computing network. Similarly, according to an aspect, such data/information are readily transferred between computing devices for storage and use according to well-known data/information transfer and storage means, including electronic mail and collaborative data/information sharing systems.

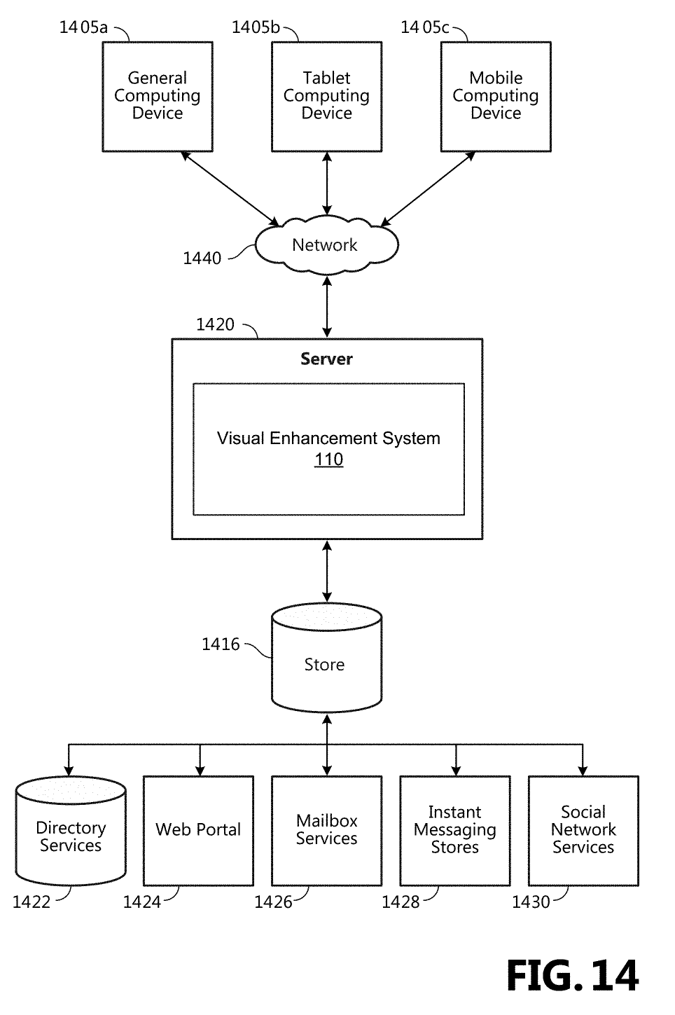

FIG. 14 illustrates one example of the architecture of a system for improving the accessibility and visibility of the displayed media as described above. Content developed, interacted with, or edited in association with the visual enhancement system 110 is enabled to be stored in different communication channels or other storage types. For example, various documents may be stored using a directory service 1422, a web portal 1424, a mailbox service 1426, an instant messaging store 1428, or a social networking site 1430. The visual enhancement system 110 is operative to use any of these types of systems or the like for improving the accessibility and visibility of the displayed media, as described herein. According to an aspect, a server 1420 provides the visual enhancement system 110 to clients 1405a,b,c. As one example, the server 1420 is a web server providing the visual enhancement system 110 over the web. The server 1420 provides the visual enhancement system 110 over the web to clients 1405 through a network 1440. By way of example, the client computing device is implemented and embodied in a personal computer 1405a, a tablet computing device 1405b or a mobile computing device 1405c (e.g., a smart phone), or other computing device. Any of these examples of the client computing device are operable to obtain content from the store 1416.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

1. A method for providing visual enhancement and cognitive assistance to improve visibility and accessibility of content, comprising:
receiving a digital content item from a media application being executed on a computing device;
extracting frames from the digital content item;
visually enhancing the frames in accordance with user-defined preferences by performing edge enhancements to emphasize the edges in the frames and performing luma/chroma enhancements to distinguish items displayed in the frames, wherein the edge enhancements are performed by analyzing each frame to identify edges between items in each frame and modifying the frame to highlight or outline the identified edges, and wherein the luma/chroma enhancements are performed by analyzing each frame to identify colors or color intensities in the frame and modifying the frame to remove a specific color, remove a specific gradient, increase the intensity of the colors or gradients, or decrease the intensity of the colors or gradients; and
displaying in real time the enhanced frames on a display of the computing device.

2. A method of claim 1, wherein the edge enhancements emphasize the edges by modifying each edge to contrast with adjacent areas.

3. A method of claim 1, wherein the luma/chroma enhancements modify colors to distinguish the items displayed in the frames.

4. A method of claim 1, wherein the luma/chroma enhancements increase or decrease intensity of colors to distinguish the items displayed in the frames.

5. A method of claim 1, wherein visually enhancing the frames includes performing coloring and/or patterning enhancements to distinguish the items displayed in the frames.

6. A method of claim 5, wherein the coloring and/or patterning enhancements apply a pattern having a distinguishable color to the items displayed in the frames to differentiation the items displayed in the frames.

7. A method of claim 1, further comprising receiving an indication to provide cognitive assistance.

8. A method of claim 7, further comprising:
generating cognitive assistance for a displayed frame; and
providing the cognitive assistance for the displayed frame.

9. A method of claim 8, wherein the frames are extracted in real time.

10. A method of claim 8, wherein generating cognitive assistance includes:
capturing text displayed in a frame;
performing optical character recognition of the text; and
audibly providing the text.

11. A method of claim 8, wherein generating cognitive assistance includes generating a scene description.

12. A method of claim 11, wherein generating the scene description includes:
capturing an image displayed in a frame;
generating a description of the image displayed in the frame; and
providing the description in an accessible mode.

13. A computer storage media including computer readable instructions, which when executed by a processing unit, performs steps for providing visual enhancement and cognitive assistance to improve visibility and accessibility of content, comprising:
receiving a digital content item from a media application being executed on a computing device;
extracting frames from the digital content item;
visually enhancing the frames in accordance with user-defined preferences by performing edge enhancements to emphasize the edges in the frames, performing luma/chroma enhancements to distinguish items displayed in the frames, and performing coloring and/or patterning enhancements to distinguish the items displayed in the frames, wherein the luma/chroma enhancements are performed by analyzing each frame to identify colors or color intensities in the frame and modifying the frame to remove a specific color, remove a specific gradient, increase the intensity of the colors or gradients, or decrease the intensity of the colors or gradients, and wherein the coloring and/or patterning enhancements are performed by analyzing each frame to identify problematic colors in the frame, mapping the locations of the problematic colors in the frame and modifying the frame by substituting a different color for the problematic color, or modifying the problematic color to include a gradient or a pattern;
displaying in real time the enhanced frames on a display of the computing device;
receiving an indication at the computing device to provide cognitive assistance;
generating cognitive assistance for a displayed frame; and
audibly presenting the cognitive assistance with an audio transducer of the computing device.

14. A computer readable media of claim 13, wherein the edge enhancements emphasize the edges by modifying each edge to contrast with adjacent areas.

15. A computer readable media of claim 13, wherein visually enhancing the frames further includes providing 3D graphic enhancements that leverage graphics processing attributes to identify where items exist in a space defined within the frame, wherein one or more items that exist within the space are visually emphasized by focusing on a selected portion of the space.

16. A computer readable media of claim 13, wherein the luma/chroma enhancements increase or decrease intensity of colors to distinguish the items displayed in the frames.

17. A computer readable media of claim 13, wherein the coloring and/or patterning enhancements apply a pattern having a distinguishable color to the items displayed in the frames to differentiation the items displayed in the frames.

18. A computer readable media of claim 13, wherein generating cognitive assistance includes:
capturing text displayed in a frame;
performing optical character recognition of the text; and
providing the text in an accessible mode.

19. A computer readable media of claim 13, wherein visually enhancing the frames further includes displaying macroblock/motion enhancements that provide improved visibility of macroblock boundaries of objects and motion vectors associated with movement of the objects.

20. A system for providing visual enhancement and cognitive assistance to improve visibility and accessibility of content, comprising:
a processing unit; and
a memory including computer readable instructions, which when executed by the processing unit, causes the system to be operable to:
receive a digital content item from a media application being executed on a computing device;
extract frames from the digital content item;
visually enhance the frames by performing:
edge enhancements to emphasize the edges in the frames, wherein the edge enhancements emphasize the edges by modifying each edge to contrast with adjacent areas;
luma/chroma enhancements to distinguish items displayed in the frames wherein the luma/chroma enhancements modify colors or intensities of colors to distinguish the items displayed in the frames; and
coloring and/or patterning enhancements to distinguish the items displayed in the frames, wherein the coloring and/or patterning enhancements apply a pattern having a distinguishable color to the items displayed in the frames to differentiation the items displayed in the frames;
display in real time the enhanced frames on a display of the computing device;
receive an indication at the computing device to provide cognitive assistance;
generate the cognitive assistance for a displayed frame, wherein the cognitive assistance includes a scene description describing the displayed frame; and
audibly present the cognitive assistance with an audio transducer of the computing device.
